(19) United States
(12) Patent Application Publication
(10) Pub. No.: US 2005/0253406 A1
(43) Pub. Date: Nov. 17, 2005

(54) Vehicle closure with multiple opening modes

(76) Inventors: Robert J. Faubert, Rochester Hills, MI (US); Hasan H. Ramouni, Dearborn, MI (US); Donald Varner, Grand Blanc, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/843,830

(22) Filed: May 12, 2004

(51) Int. Cl. B60J 5/10

(52) U.S. Cl. 296/51

(57) ABSTRACT

A tailgate door module that will fit in the existing opening of rear compartment of a vehicle adapted to receive a conventional liftgate includes a perimeter frame corresponding to the outer boundary of the liftgate, and mounted to the vehicle in like fashion. A fold-down tailgate is pivotally mounted to a lower portion of the perimeter frame, and is adapted to latch in a closed position conforming to the rear of the vehicle and occupying a lower portion of the perimeter frame, or to pivot downwardly to present a load-bearing platform. The upper portion of the perimeter frame is occupied by a window pivotally mounted to an upper extent of the perimeter frame, and latchable to the tailgate, so that the lift glass and tailgate close the opening of the vehicle and perimeter frame.

### BACKGROUND OF THE INVENTION

1. Field of the Invention

The invention relates to closure panels, and particularly to a multi-function motor vehicle closure.

2. Description of Related Art

Motor vehicles are used for multiple purposes, including carrying passengers and cargo, and often function as a mobile base of operation for today's active families. This role is particularly suited to the perennially favorite minivan, to the sport utility vehicle, and to the variations on these themes appearing in the marketplace. Other uses of the family vehicle include picnics or just sitting on the tailgate watching the kids play ball.

It would be advantageous to provide a vehicle closure system have multiple modes of opening for convenience and ease of loading, for retaining cargo when needed, and for providing a load-supporting platform.

### BRIEF SUMMARY OF THE INVENTION

A closure assembly for pivotally mounting in a vehicle body opening having a perimeter comprising an upper boundary, a lower boundary and opposing side boundaries, includes a frame configured to extend to the boundaries of the opening, conforming closely to the perimeter of the opening, and pivotable from an open position to a closed position covering the opening, a lower closure pivotally mounted to the frame and pivotable from an open position forming a support shelf to a closed position parallel with the frame, and an upper closure pivotally mounted to the frame and pivotable from an open position to a closed position, and operable independent of the lower closure. In one embodiment, the frame comprises a hydro-formed section.

### BRIEF DESCRIPTION OF THE SEVERAL VIEWS OF THE DRAWINGS

The present invention will become more fully understood from the detailed description and the accompanying drawings, wherein:

FIG. 1 is a rear perspective view of a motor vehicle having a vehicle closure with multiple opening modes according to the invention.

FIG. 2 is a rear perspective view of the motor vehicle of FIG. 1 with the vehicle closure in a first opening mode.

FIG. 3 is a rear perspective view of the motor vehicle of FIG. 1 with the vehicle closure in a second opening mode.

FIG. 4 is a rear perspective view of the motor vehicle of FIG. 1 with the vehicle closure in a third opening mode.

FIG. 5 is a perspective view of a perimeter frame of the vehicle closure of FIGS. 1-4.

### DETAILED DESCRIPTION OF THE INVENTION

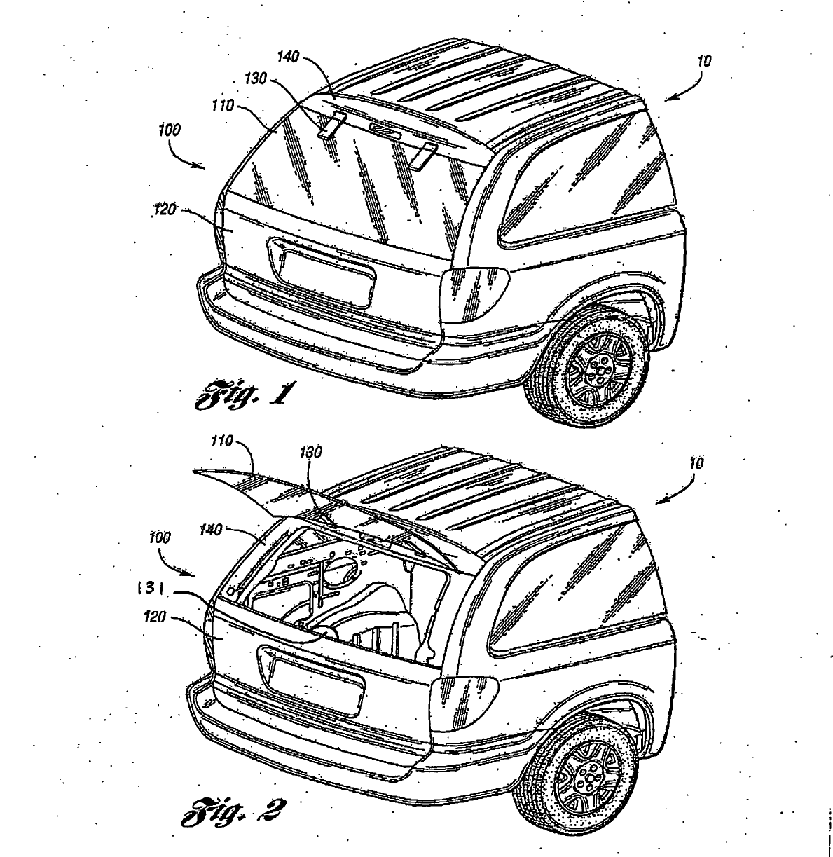

Referring to FIG. 1, a rear portion of a motor vehicle 10 is shown with a vehicle closure 100 having multiple opening modes according to the invention. The vehicle closure 100 is composed of an upper closure member 110 and a lower closure member 120 each pivotally mounted to a perimetric frame member 140. As shown in FIG. 1, upper closure member 110 is pivotally mounted to frame member 140 by a pair of hinges 130.

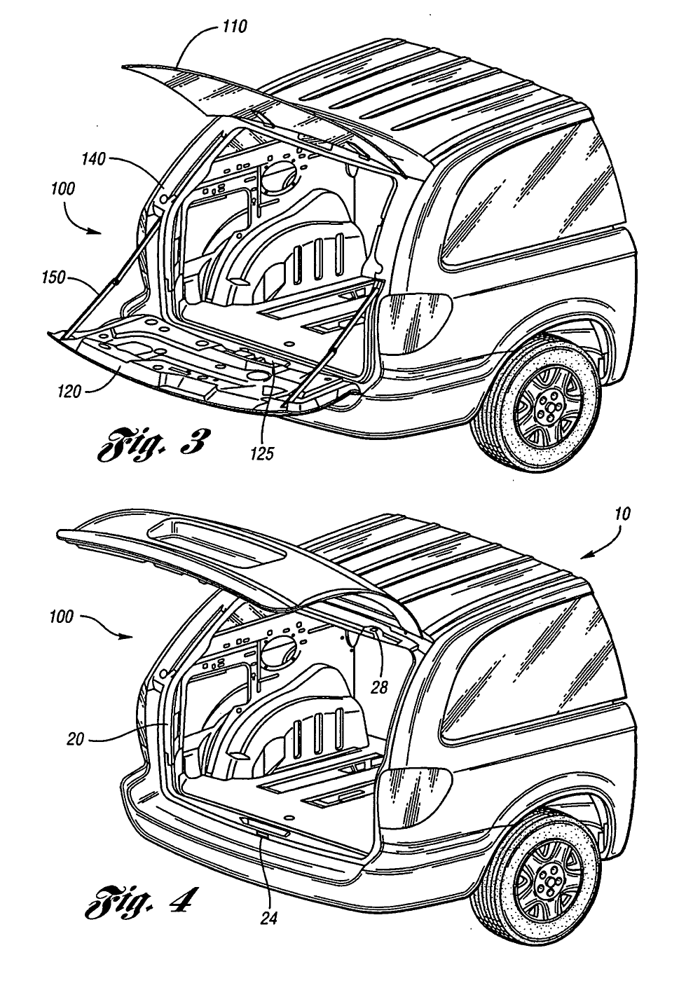

With reference now to FIG. 2, the vehicle closure 100 is illustrated in a first opening mode, wherein the upper closure member 110, shown here as a glass or transparent panel, has been released from its closed position and raised, pivoted about hinges 130, to an open position. The upper closure member 110 can be raised manually or by a lift strut mechanism (not shown), or the hinges 130 can be internally spring-loaded to raise the upper closure member 110 upon release of its locking mechanism.

The first opening mode of FIG. 2 provides an unobstructed upper opening for access to the interior of the vehicle 10. The lower closure member 120 continues to cover the lower portion of the vehicle opening to retain items within the vehicle 10.

A second opening mode is illustrated in FIG. 3, wherein the lower closure member 120 has been pivoted about a lower hinge or hinges 125. The upper hinges 130 and lower hinges 125 pivotally mount the upper closure member 110 and lower closure member 120, respectively, to the perimetric frame member 140 (see also FIG. 5).

As shown in FIG. 3, the lower closure member 120 is pivoted downward about lower hinges 125 to a generally horizontal position, forming a tailgate. The lower closure member 120 is further supported by a pair of articulated links 150, each of the links 150 being pivotally mounted to an edge of the lower closure member 120 and to the perimetric frame member 140. The lower closure member 120 is thereby supported in the horizontal position by the lower hinges 125 and the links 150.

The second opening mode shown in FIG. 3 has several advantages or features. With upper and lower closure members 110, 120 open, the user has complete access to the interior of the vehicle 10. The upper closure member 110 is pivoted up out of the way to provide head clearance for a person reaching into the vehicle. The lower closure member 120 provides a horizontal support surface for sitting or for use as a table.

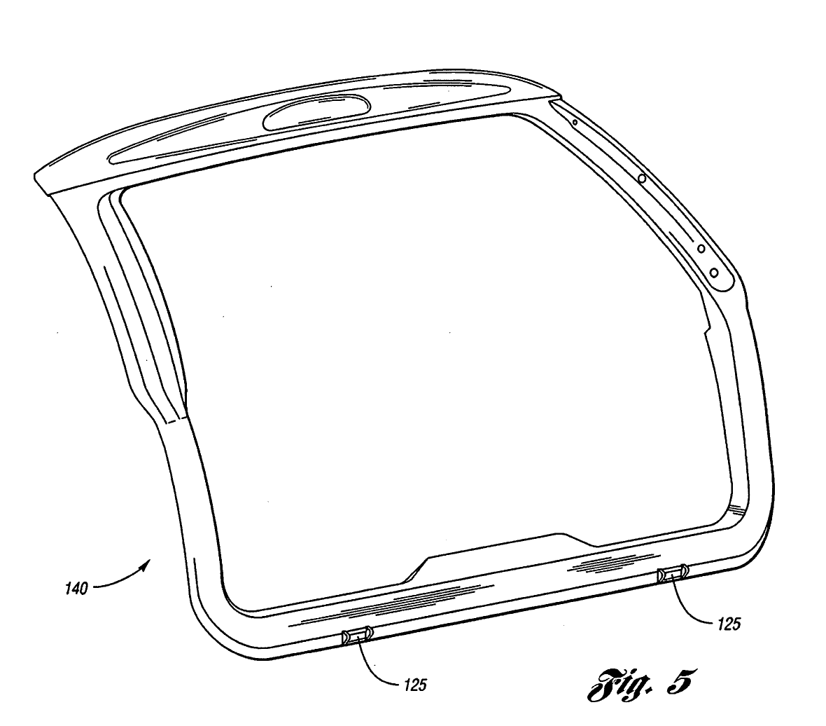

Referring now to FIG. 4, a third opening mode is illustrated. The upper and lower closure members 110, 120 have been rotated back into the closed position of FIG. 1, generally parallel and conforming with the perimetric frame 140. The frame 140 is pivotally mounted to the vehicle opening 20 at upper hinges 28, and held in the closed position of FIG. 1 by a latch mechanism 24 (see FIG. 4), as is commonly used in vehicle liftgates. The frame 140 can be a hydro-formed section or can be formed by stamping.

With the latch mechanism released, the vehicle closure 100 pivots as a unit about upper hinges 28 in the fashion of a liftgate. Upper and lower closure members 110, 120 are secured to frame member 140. Frame member 140 pivots about upper hinges 28, carrying upper and lower closure members 110, 120 with it.

In the third opening mode, the vehicle closure 100 demonstrates the advantages of the conventional liftgate. The vehicle closure 100 according to the invention can be formed in such a way that it is interchangeable with a conventional liftgate in a particular vehicle 10, so that it might be available for selection by a consumer as an option or retrofit to an existing vehicle 10.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the scope of the appended claims.

1. A closure assembly for pivotally mounting in a vehicle body opening, the opening having a perimeter comprising an upper boundary, a lower boundary and opposing side boundaries, the closure assembly comprising;
a perimetric frame defining an opening having an inner perimeter substantially conforming to the vehicle body opening, the perimetric frame configured to extend to the boundaries of the vehicle body opening, and pivotable from an open position to a closed position;
a lower closure pivotally mounted to the frame and pivotable from an open position forming a support shelf to a closed position parallel with the frame; and
an upper closure pivotally mounted to the frame and pivotable from an open position to a closed position, operable independent of the lower closure.

2. The closure assembly of claim 1, wherein the upper closure comprises a transparent panel pivotally mounted to the frame at an upper extent thereof.

3. The closure assembly of claim 2, wherein the upper closure is releasably latched to the lower closure at a lower extent thereof.

4. The closure assembly of claim 1, wherein the upper closure is releasably latched to the lower closure.

5. The closure assembly of claim 1, wherein the frame is pivotally mounted to the upper boundary of the opening.

6. The closure assembly of claim 1, wherein the lower closure forms a seal with the frame about a lower extent of the frame.

7. The closure assembly of claim 6, wherein the upper closure forms a seal with the frame about an upper extent of the frame and with the lower closure at an upper extent thereof.

8. The closure assembly of claim 1, wherein the upper closure forms a seal with the frame about an upper extent of the frame.

9. The closure assembly of claim 1, wherein the frame comprises a hydro-formed section.

10. A vehicle closure assembly with multiple opening modes, for pivotally mounting in a vehicle body opening configured for receiving a conventional closure, the opening having a perimeter comprising an upper boundary, a lower boundary and opposing side boundaries, the closure assembly comprising:
a perimetric frame defining an opening having an inner perimeter substantially conforming to the perimeter of the vehicle body opening;
an upper closure panel pivotally mounted to the frame and pivotable from an open position to a closed position; and
a lower closure pivotally mounted to the frame and pivotable from an open position forming a support shelf to a closed position parallel with the frame.

11. The closure assembly of claim 10, wherein the upper closure comprises a transparent panel pivotally mounted to the frame at an upper extent thereof.

12. The closure assembly of claim 11, wherein the upper closure is releasably latched to the lower closure at a lower extent thereof.

13. The closure assembly of claim 10, wherein the upper closure is releasably latched to the lower closure.

14. The closure assembly of claim 10, wherein the frame comprises a hydro-formed section.
